(19) United States
(12) Patent Application Publication
(10) Pub. No.: US 2023/0177384 A1
(43) Pub. Date: Jun. 8, 2023

(54) Attention Bottlenecks for Multimodal Fusion

(71) Applicant: Google LLC, Mountain View, CA (US)

(72) Inventors: Arsha Nagrani, Cambridge, MA (US); Shan Yang, Sunnyvale, CA (US); Anurag Arnab, Grenoble (FR); Chen Sun, San Francisco, CA (US); Cordelia Luise Schmid, Saint-Ismier (FR)

(21) Appl. No.: 17/545,526

(22) Filed: Dec. 8, 2021

(51) Int. Cl. G06N 20/00; G06N 5/04

(52) U.S. Cl. CPC G06N 20/00; G06N 5/04

(57) ABSTRACT

Example embodiments according to aspects of the present disclosure provide an example computer-implemented method for multimodal data processing with improved cross-modal attention. The example method includes inputting a multimodal sequence to an example machine-learned model. The example model includes a first modal processing stream receiving a first modal portion of the multimodal sequence and a second modal processing stream receiving a second modal portion of the multimodal sequence. The example model includes fusing the first modal processing stream and the second modal processing stream across one or more fusion layers of the machine-learned model through a plurality of cross-modal context encodings. The example method includes outputting an inference based at least in part on the plurality of cross-modal context encodings.

### FIELD

The present disclosure relates generally to machine-learned model architectures. More particularly, the present disclosure relates to machine-learned model architectures for processing multimodal data.

### BACKGROUND

Humans perceive the world by concurrently processing and fusing high-dimensional inputs from multiple modalities such as vision and audio. For artificial learning systems, however, designing a unified model for modality fusion can be challenging due to a number of factors, including (i) possible variations in learning dynamics between modalities, (ii) possible different noise topologies, with, for example, some modality streams containing more information for the task at hand than others, and (iii) possible specialized input representations.

### SUMMARY

Aspects and advantages of embodiments of the present disclosure will be set forth in part in the following description, or can be learned from the description, or can be learned through practice of the embodiments.

In one example aspect, the present disclosure provides for an example system for multimodal data processing with improved cross-modal attention. The example system includes one or more processors and one or more non-transitory computer-readable media that collectively store instructions. In the example system, the instructions, when executed by the one or more processors, cause the example system to perform operations. In the example system, the operations include inputting a multimodal sequence to a machine-learned model. In the example system, the machine-learned model includes a first modal processing stream receiving a first modal portion of the multimodal sequence and a second modal processing stream receiving a second modal portion of the multimodal sequence. In the example system, the operations include fusing the first modal processing stream and the second modal processing stream across one or more fusion layers of the machine-learned model through a plurality of cross-modal context encodings. In the example system, the operations include outputting an inference based at least in part on the plurality of cross-modal context encodings.

In another example aspect, the present disclosure provides for an example computer-implemented method for multimodal data processing with improved cross-modal attention. The example method includes inputting, by a computing system including one or more processors, a multimodal sequence to a machine-learned model. In the example method, the machine-learned model includes a first modal processing stream receiving a first modal portion of the multimodal sequence and a second modal processing stream receiving a second modal portion of the multimodal sequence. The example method includes fusing, by the computing system, the first modal processing stream and the second modal processing stream across one or more fusion layers of the machine-learned model through a plurality of cross-modal context encodings. The example method includes outputting, by the computing system, an inference based at least in part on the plurality of cross-modal context encodings.

In another example aspect, the present disclosure provides for an example system for audiovisual data processing with improved cross-modal attention. The example system includes one or more processors and one or more non-transitory computer-readable media that collectively store instructions. In the example system, the instructions, when executed by the one or more processors, cause the system to perform operations. In the example system, the operations include inputting a multimodal sequence to a machine-learned model. In the example system, the machine-learned model includes a visual processing stream receiving a visual portion of the multimodal sequence and an audio processing stream receiving an audio portion of the multimodal sequence. In the example system, the operations include fusing the visual processing stream and the audio processing stream across one or more fusion layers of the machine-learned model through a plurality of cross-modal context encodings. In the example system, the cross-modal context encodings represent concentrated attention flow between the visual processing stream and the audio processing stream. In the example system, the one or more fusion layers follow one or more unfused layers. In the example system, the operations include outputting an inference based at least in part on the plurality of cross-modal context encodings.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures.

FIG. 1A depicts a block diagram of an example computing system that performs machine-learned multimodal data processing according to example embodiments of the present disclosure.

FIG. 1B depicts a block diagram of an example computing device that performs machine-learned multimodal data processing according to example embodiments of the present disclosure.

FIG. 1C depicts a block diagram of an example computing device that performs machine-learned multimodal data processing according to example embodiments of the present disclosure.

FIG. 2 depicts a block diagram of an example machine-learned multimodal fusion system according to example embodiments of the present disclosure.

FIG. 3 depicts a block diagram of example aspects of an example machine-learned multimodal fusion model according to example embodiments of the present disclosure.

FIG. 4A depicts a block diagram of example aspects of an example machine-learned multimodal fusion model according to example embodiments of the present disclosure.

FIG. 4B depicts a block diagram of example aspects of an example machine-learned multimodal fusion model according to example embodiments of the present disclosure.

FIG. 5 depicts a block diagram of example aspects of an example machine-learned multimodal fusion model according to example embodiments of the present disclosure.

FIG. 6 depicts a block diagram of example aspects of an example machine-learned multimodal fusion model according to example embodiments of the present disclosure.

FIG. 7A depicts a flow chart diagram of an example method to perform machine-learned multimodal data processing according to example embodiments of the present disclosure.

FIG. 7B depicts a flow chart diagram of an example method to perform machine-learned multimodal data processing according to example embodiments of the present disclosure.

FIG. 8A depicts a charted performance comparison of an example embodiment of an example machine-learned multimodal fusion model according to example embodiments of the present disclosure (solid line) with a baseline (dashed line).

FIG. 8B depicts a charted performance comparison of an example embodiment of an example machine-learned multimodal fusion model according to example embodiments of the present disclosure (solid line) with a baseline (dashed line).

Reference numerals that are repeated across plural figures are intended to identify the same features in various implementations.

### DETAILED DESCRIPTION

Overview

Generally, the present disclosure is directed to systems and methods for machine-learned multimodal data processing. More particularly, example embodiments provide for jointly processing multiple modalities of corresponding data (e.g., visual and audio data of a video capture) while leveraging more efficient cross-modal attention. In some machine-learned models, “attention” can provide a mechanism for processing one portion of an input in view of other portions of the input. In this manner, the models can better understand the inputs in context.

For example, example embodiments of the present disclosure advantageously provide for improved multimodal “fusion”—for example, the processing of one modality in a multimodal input (e.g., video) in the context of (e.g., with attention to) another modality of the input (e.g., audio). For instance, audio cues taken together with visual inputs are often helpful to guide and/or confirm identification of visual subjects (e.g., a roaring plane vs. gliding bird, etc.) as well as supporting improved high-level understandings of a video sequence as might be apparent to a human observer (e.g., a slammed door as compared to a softly closed door, etc.). In this manner, for instance, example embodiments of the present disclosure can provide for improved cross-modal attention.

Past approaches to multimodal fusion have faced a number of challenges. Designing a unified model for modality fusion can be challenging due to, for example, variations in learning dynamics between modalities, different noise topologies between modalities (e.g., with some modality streams containing more information for the task at hand than others), and different input representations between modalities. As one example, the difference in input representations between audio and vision can be particularly stark. Many past approaches to single-mode audio classification methods rely on short term Fourier analysis to produce log-mel spectrograms, often using them as inputs to convolutional neural network (CNN) architectures designed for images. These time-frequency representations can have different distributions to images (e.g., multiple acoustic objects can have energy at the same frequency), and the translation invariances of CNNs may no longer be a desired property (e.g., while an acoustic object can be shifted in time, a shift in frequency could alter the meaning entirely). In contrast, the visual data stream for a video can be represented as three-dimensional (two spatial and one temporal), and while different spatial regions of the image can correspond to different objects, there can be a unique challenge of high redundancy across multiple frames.

Due to these challenges, some past approaches to multimodal fusion simply integrate separate audio and visual networks at their outputs in a “late fusion” scheme in which an overall output is based on the separately-computed modal outputs. Such approaches often forgo rich contextual information between corresponding modalities. Some other past approaches to multimodal fusion simply combine (e.g., sum, concatenate, etc.) audio and visual features for processing to obtain, for example, full cross-modal attention at the cost of excess compute requirements and limited scalability (e.g., due to fully-connected pairwise attention over dense—and often highly redundant—audiovisual input data).

In contrast, example embodiments of the present disclosure advantageously provide a unified model structure for jointly processing multimodal input data with more efficient cross-modal attention. For instance, example embodiments of the present disclosure introduce cross-modal context encodings for concentrating attention flow across modalities. For example, a multimodal input can include data from a plurality of modalities. An example multimodal fusion model of the present disclosure can process each modality of the input in view of (e.g., with attention to) one or more other modalities attending over a set of cross-modal context encodings. In some examples, the set of cross-modal context encodings can pass contextual information between each of the one or more other modalities. In some examples, the dimensionality of the set of cross-modal context encodings can be smaller (e.g., significantly smaller) than the dimensionality of the one or more other modalities of the input (e.g., taken individually and/or together). In this manner, attention flow between modalities can be concentrated through a “bottleneck” formed by the reduced-dimensionality of the cross-modal context encodings, and attention to the set of cross-modal context encodings can provide for rich contextual data flow across modalities at a reduced computational complexity.

For instance, in one example embodiment, a multimodal fusion model according to example aspects of the present disclosure can be or include a self-attention model, such as a transformer model. For instance, in some example embodiments, a multimodal fusion model can include a plurality of parallel modal processing streams that respectively process a portion of an input sequence corresponding to an individual modality. In some embodiments, the streams each include a mechanism for attention (e.g., self-attention, pairwise attention) over respective inputs thereto. In some embodiments, a set of cross-modal context encodings can be determined based on both modal streams to capture contextual information from the corresponding modalities. In some embodiments, for instance, the cross-modal context encodings have lower dimensionality than a direct modal input to a respective stream, such that attending over the cross-modal context encodings is computationally cheaper (e.g., requires fewer model computes, etc.) than attending over the full width of the input sequence. Thus, the set of cross-modal context encodings can be used as inputs at one or more points along the modal processing streams, such that the respective streams attend to the cross-modal context encodings in addition to their direct modal inputs (e.g., as passed along via their respective stream), thereby performing context-aware modal processing with reduced computational cost.

Example embodiments of systems and methods of the present disclosure provide for a number of technical effects and benefits. For instance, example embodiments of the presently disclosed multimodal fusion model can leverage rich contextual information across a plurality of input modalities to obtain inferences (e.g., predictions, classifications, characterizations, etc.) with improved accuracy, precision, speed, and/or computational efficiency. For instance, example embodiments of the presently disclosed multimodal fusion model can process visual data inputs in view of corresponding audio cues obtained from audio inputs, while also processing the audio data inputs in view of corresponding visual cues obtained from the visual inputs. In this manner, example embodiments of the presently disclosed multimodal fusion model can advantageously obtain inferences not only from the direct data modality inputs (e.g., the audio data, the visual data, etc.) but also from contextual interactions therebetween. Thus, for instance, example embodiments of the presently disclosed multimodal fusion model can provide for improved data efficiency for obtaining quality inferences with less computational expense (e.g., processing cycles and/or memory usage in data gathering, indexing, labeling, storing, retrieval, etc.; processing cycles and/or memory usage in computation in training, at runtime, etc.).

In another aspect, for instance, example embodiments of systems and methods employing the presently disclosed multimodal fusion model can provide for the above advantages of cross-modal context awareness with reduced computational complexity. For example, the cross-modal context encodings can provide for the communication of contextual information obtained from the respective other modalities and concentrated into a reduced-dimensional representation. For instance, in some embodiments, one or more layers of a multimodal fusion model can restrict attention to flow through the cross-modal context encodings, forcing the cross-modal context encodings to learn to pass pertinent features and other information between modalities while requiring fewer update compute steps than, for instance, full pairwise attention across the entire multimodal input. In this manner, for instance, example embodiments of systems and methods employing the presently disclosed multimodal fusion model can reduce a computational requirement (e.g., processor requirement, memory requirement, bandwidth requirement, etc.) for context-aware multimodal data processing.

In another aspect, for instance, example embodiments of systems and method employing the presently disclosed multimodal fusion model can provide for context-aware processing of raw video and/or audio data (e.g., video frame pixel data, audio sample data, etc.) in a multimodal input. For instance, because example embodiments of cross-modal context representation provide for reduced-dimensional representations of cross-modal context, example embodiments according to the present disclosure can enable computation of context over relatively dense modal inputs, such as generally correspond to raw video and/or audio data. In this manner, for instance, computational requirements for processing multimodal inputs may be reduced by not requiring the preconditioning of the input(s) (e.g., reducing storage required and/or processing cycles required by avoiding generating intermediate input(s), etc.).

With reference now to the Figures, example embodiments of the present disclosure will be discussed in further detail.

### Example Devices and Systems

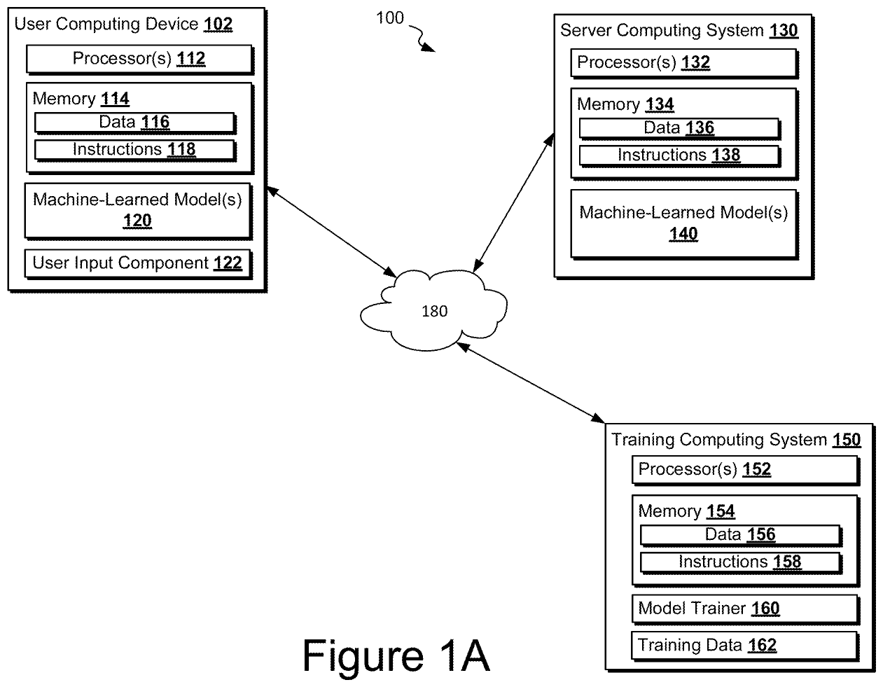

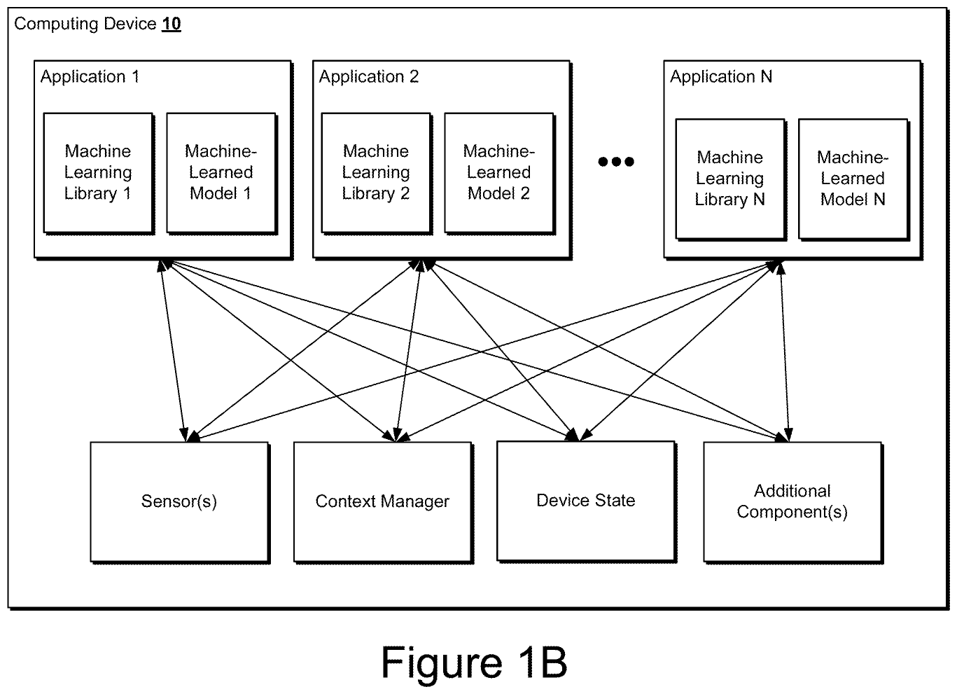

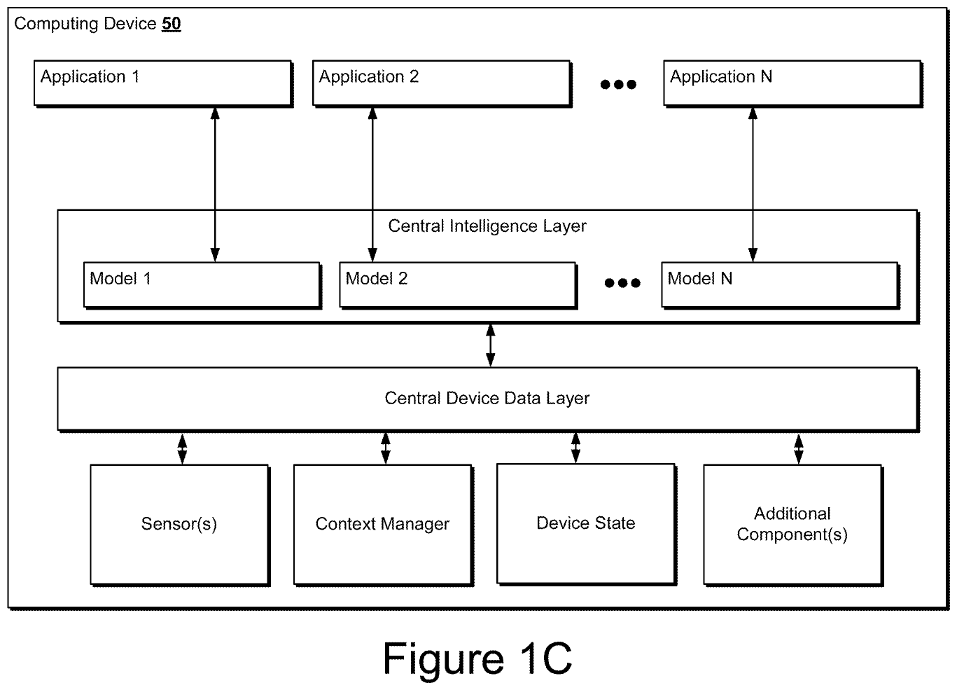

FIG. 1A depicts a block diagram of an example computing system 100 that performs machine-learned multimodal data processing according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

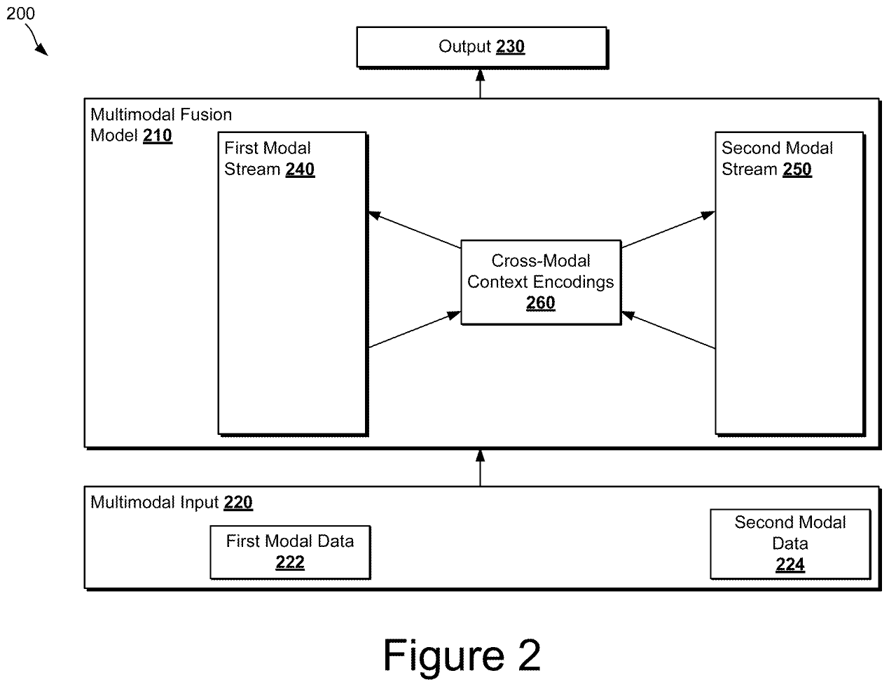

In some implementations, the user computing device 102 can store or include one or more machine-learned multimodal fusion models 120. For example, the machine-learned multimodal fusion models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned multimodal fusion models 120 are discussed with reference to FIGS. 2 to 8B.

In some implementations, the one or more machine-learned multimodal fusion models 120 can be received from the server computing system 130 over network 180, stored in the user computing device memory 114, and then used or otherwise implemented by the one or more processors 112. In some implementations, the user computing device 102 can implement multiple parallel instances of a single machine-learned multimodal fusion model 120 (e.g., to perform parallel machine-learned multimodal fusion across multiple instances).

Additionally or alternatively, one or more machine-learned multimodal fusion models 140 can be included in or otherwise stored and implemented by the server computing system 130 that communicates with the user computing device 102 according to a client-server relationship. For example, the machine-learned multimodal fusion models 140 can be implemented by the server computing system 130 as a portion of a web service (e.g., a machine-learned multimodal data processing service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned multimodal fusion models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2 to 8B.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned multimodal fusion models 120 and/or 140 based on a set of training data 162. The training data 162 can include, for example, annotated multimodal data (e.g., data including a plurality of data modes with at least one mode associated with labels).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, one or more modalities of the input to the machine-learned model(s) of the present disclosure can be image data (e.g., still image data, one or more video frames, etc.). The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, one or more modalities of the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, one or more modalities of the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, one or more modalities of the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, one or more modalities of the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, one or more modalities of the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, one or more modalities of the input includes visual data, and the task is a computer vision task. In some cases, one or more modalities of the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, one or more modalities of the input includes audio data, and the task is an audio classification task. In some cases, one or more modalities of the input includes waveform data (e.g., magnitude, frequency, etc.) for one or more audio recordings and the task is an audio processing task. For example, the audio processing task can be audio classification, where the output is a set of scores, each score corresponding to a different object class and representing the likelihood that the one or more audio recordings depict an object belonging to the object class. The audio processing task may be object detection, where the audio processing output identifies one or more regions in the one or more audio recordings (e.g., segments, such as segments having a start and finish time) and, for each region, a likelihood that region depicts an object of interest. As another example, the audio processing task can be audio segmentation, where the audio processing output defines a respective classification likelihood for one or more portions of an audio signal for each category in a predetermined set of categories. For example, the set of categories can be foreground and background. As another example, the set of categories can be object classes. As another example, the audio processing task can be distance estimation, where the image processing output defines a respective distance value (e.g., away from a signal sourcing/receiving point). As another example, the audio processing task can be motion estimation, where the network input includes multiple audio channels, and the audio processing output defines a motion of the scene depicted by the audio signals (e.g., movement of a signal sourcing/receiving point).

In some cases, one or more modalities of the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example machine-learned multimodal fusion system 200 according to example embodiments of the present disclosure. In some implementations, the machine-learned multimodal fusion model 210 (e.g., corresponding to multimodal fusion model(s) 120, 140) is trained to receive a set of input data 220 containing a plurality of data modalities (e.g., first modal data 222 and second modal data 224) and, as a result of processing the input data 220 with a first modal stream 240 and a second modal stream fused through cross-modal context encodings 260, provide output data 230 that sets forth inferences regarding the input data 220.

Multimodal fusion model 210 can be or include one or more (e.g., a plurality of) machine-learned models. For example, multimodal fusion model 210 can include a neural network configured with an attention mechanism for attending over the context of an input (e.g., attending over a context of a portion of the input). In some example embodiments, multimodal fusion model 210 can include a self-attention model, such as a transformer model. In some embodiments, a transformer model can include an encoder containing a sequence of transformer layers. For instance, in some embodiments, a transformer layer can include multi-headed self-attention operations. In some embodiments, a transformer layer can include multilayer perceptron blocks applied over an output of the multi-headed self-attention operations.

In some embodiments, first modal stream 240 and second modal stream 250 share one or more learnable parameters. In some embodiments, first modal stream 240 and second modal stream 250 contain one or more separate learnable parameters. For example, in some embodiments, each of first modal stream 240 and second modal stream 250 are parameterized by separate learnable parameters.

For example, in some embodiments, each of first modal stream 240 and second modal stream 250 can include an individually parameterized transformer model, and the respective models can be in communication through shared tokens (e.g., the cross-modal encodings 260). In general, the techniques introduced in the present disclosure for constructing multimodal fusion models (e.g., multimodal fusion model 210) are model-agnostic, such that a wide variety of model architectures can be used as a backbone for the respective modal processing streams (e.g., first modal stream 240, second modal stream 250, etc.).

In some example embodiments, any one or more of first modal stream 240 and second modal stream 250 can include a mechanism for attention (e.g., self-attention, pairwise attention, etc.) over respective inputs thereto. One or more of the cross-modal context encodings 260 can be used as inputs at one or more points along first modal stream 240 and second modal stream 250 such that the respective streams attend to the cross-modal context encodings 260 as well as their direct modal inputs (e.g., first modal data 222, second modal data 224, etc.). In some embodiments, for instance, the cross-modal context encodings 260 have lower dimensionality than any one or more of the first modal data 222 and the second modal data 224, such that attending over the cross-modal context encodings 260 is computationally cheaper (e.g., requires fewer model computes, etc.) than attending over the full dataset for the counterpart modality.

In some embodiments, multimodal input 220 can include a plurality of data modalities. In general, multimodal input 220 can include substantially any kind of data desired to be processed in the context of any other kind of data. For instance, in some embodiments, multimodal input 220 can include any one or more of video data, image data, audio data, location data, vibration data, etc. For instance, in some embodiments, multimodal input 220 can include any one or more of weather data, financial data, traffic data, telemetry data, diagnostic data, etc. The example data modalities mentioned herein are presented for illustrative purposes only, and are not listed by way of limitation.

In some embodiments, output 230 can include substantially any output based on the multimodal input 220. In some embodiments, the output 230 includes an inference based on the multimodal input 220. For instance, in some embodiments, the output 230 can include predictions, classifications, characterizations, estimates, interpretations, scores, segmentations, probability distributions, logits, etc. In some embodiments, the output 230 can be based at least in part on an intermediate output of one or more modal streams (e.g., first modal stream 240, second modal stream 250, etc.). For example, in some embodiments, a first modal stream 240 can provide an intermediate output based at least in part on its respective modal inputs (e.g., first modal data 222) and based at least in part on an attention flow (e.g., attention over cross-modal context encodings 260). Similarly, in some embodiments, a second modal stream 250 can provide an intermediate output based at least in part on its respective modal inputs (e.g., second modal data 224) and based at least in part on an attention flow (e.g., attention over cross-modal context encodings 260). The intermediate output(s) can, in some embodiments, be descriptive of an output from the perspective of the respective stream(s) (e.g., a prediction output, a classification output, etc.). In this manner, for example, corroborate between a plurality of intermediate outputs to determine the output 230. For example, in some embodiments, the output 230 can include an average of a plurality of intermediate outputs (e.g., from each of a plurality of modal processing streams).

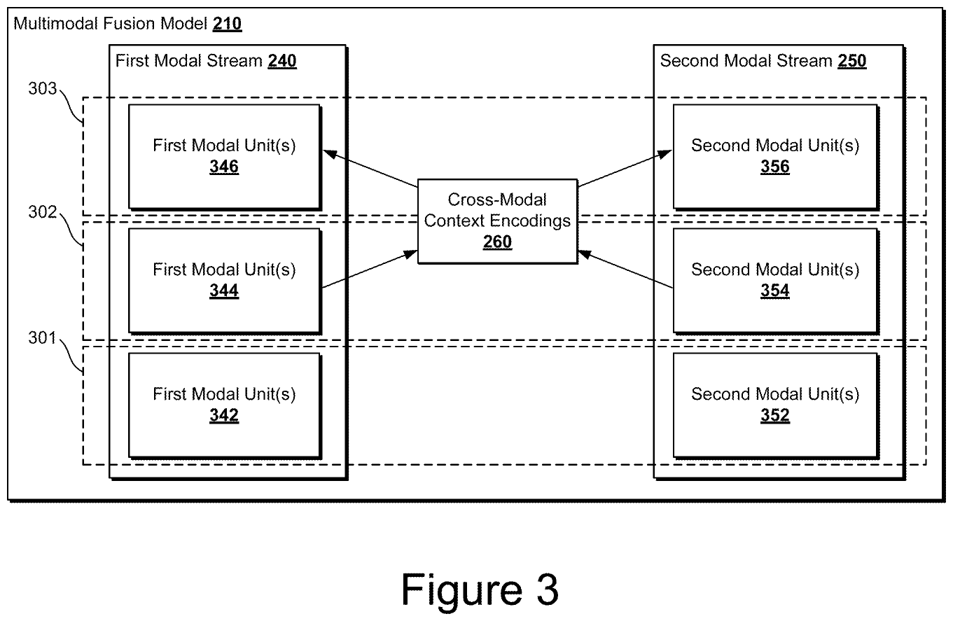

FIG. 3 depicts a block diagram of an example machine-learned multimodal fusion model 210 according to example embodiments of the present disclosure, illustrating a “mid fusion” model arrangement in which one or more unfused layers precede one or more fusion layers. In the example illustrated in FIG. 3, machine-learned multimodal fusion model 210 includes at least three layers—portion 301, containing one or more layers; portion 302, containing one or more layers; and portion 303, containing one or more layers. In the example illustrated in FIG. 3, the first modal stream 240 and the second modal stream 250 each contain a set of modal units (e.g., nodes, such as one or more nodes updated in a plurality of iterations, etc.). In portion 301, first modal unit(s) 342 and second modal unit(s) 352 operate over the data in their respective streams (e.g., respective modal portions of the multimodal input 220). In some embodiments, in portion 301, first modal unit(s) 342 and second modal unit(s) 352 process the data in their respective streams without reference or attention to their respective counterpart stream. For instance, portion 301 can include “unfused” layers.

In some embodiments, for example, early layers of a network (e.g., multimodal fusion model 210) may be configured to focus on unimodal processing, with cross-modal connections introduced at later layers. In some example embodiments, lower layers can generally be involved in processing low level features, while higher layers can generally be focused on learning semantic concepts—for instance, in an audiovisual context, some low-level visual features, such as edges and corners in images, might have less direct relationship to a particular sound signature as compared to a high-level semantic concept such as, for instance, a recognized semantic concept of a “trumpet” in an image. In this manner, for instance, in some embodiments, cross-modal connections can provide increased benefit at later layers, and fewer cross-modal connections (e.g., decreasing a computational cost) might be implemented at lower layers, in some embodiments.

In portion 302, first modal unit(s) 344 and second modal unit(s) 354 can process the data in their respective streams. However, in some embodiments, one or both of first modal unit(s) 344 and second modal unit(s) 354 can pass information to one or more of the cross-modal context encodings 260. And in some embodiments, in portion 303, first modal unit(s) 346 and second modal unit(s) 356 process the data in their respective streams in view of the cross-modal context encodings 260. For instance, in some embodiments, the first modal unit(s) 346 and second modal unit(s) 356 can receive as an input one or more of the cross-modal context encodings 260, for example, along with intermediate data passed along the respective modal stream, and execute an attention mechanism over the intermediate data and the cross-modal context encodings 260. For example, portion 303 can include one or more “fused” or “fusion” layers.

Although the discussion of the figures (e.g., FIG. 3) may make reference to one or more “layers,” it is to be understood that a layer can include a set of iterative model operations that can iteratively (e.g., recursively) operate over one or more input state(s). Thus, although the figures (e.g., FIG. 3) may make reference to “preceding” and “subsequent” layers, it is to be understood to include preceding and subsequent iterations of, for instance, a single layer. Similarly, although the figures (e.g., FIG. 3) may make reference to a plurality of modal units (e.g., first modal unit(s) 342, 344, 346; second modal unit(s) 352, 354, 356; nodes; etc.), it is to be understood to include iterative operation of a single set of modal units (e.g., corresponding to a set of learnable parameters used for the iteration(s), etc.).

In some embodiments, multimodal fusion model 210 can include a transformer model. In some embodiments, a transformer model can include an encoder containing a sequence of transformer layers. In some embodiments, a sequence of transformer layers can include one or more iterations through a single layer or set of layers, such as iterations through portions 301, 302, 303, etc. In some embodiments, one or more iterations through portion 301 can be followed by one or more iterations through a different single layer or set of layers, such as through portions 302 and 303. For example, in some embodiments, a transformer update layer z^{l+1}=f(z^{l}) can be expressed as follows.

y^{l}=MSA(LN(z^{l}))+z^{l} (1)

z^{l+1}=MLP(LN(y^{l}))+y^{l} (2)

where the MSA operation computes dot-product attention where queries Q, keys K, and values V are all linear projections of the same tensor, MSA(X)=Attention(W^{Q}X, W^{K}X, W^{v}X). In this example expressive framework, an example embodiment of a transformer layer with cross-modal information interchange through cross-modal context encodings z_{cross-mode} can be expressed as follows,

[z_{first mode}^{l+1},z_{cross-mode}^{l+1}]=f(z_{first mode}^{l},z_{cross-mode}^{l};θ_{first mode}) (3)

[z_{second mode}^{l+1},z_{cross-mode}^{l+1}]=f(z_{second mode}^{l},z_{cross-mode}^{l};θ_{second mode}) (4)

where θ_{first mode} and θ_{second mode} indicate machine-learned parameters for computing the updates, and wherein θ_{first mode} and θ_{second mode} can be the same or different.

In some embodiments, for instance, updates to a first modal portion of one or more layers (e.g., an l+1 layer) can be computed in view of a first modal portion of a preceding layer (e.g., an l layer) and in view of (e.g., attending over) one or more cross-modal context encodings of the preceding layer. In some embodiments, the cross-modal context encodings in the layer (e.g., the l+1 layer) can also be updated in view of the first modal portion of a preceding layer (e.g., an l layer) and in view of one or more cross-modal context encodings of the preceding layer.

In some embodiments, for instance, updates to a second modal portion of one or more layers (e.g., an l+1 layer) can be computed in view of a second modal portion of a preceding layer (e.g., an l layer) and in view of one or more cross-modal context encodings of the preceding layer. In some embodiments, the cross-modal context encodings in the layer (e.g., the l+1 layer) can also be updated in view of the second modal portion of a preceding layer (e.g., an l layer) and in view of one or more cross-modal context encodings of the preceding layer.

In this manner, for instance, the cross-modal context encodings can be determined based at least in part on both the first modal stream 240 and the second modal stream 250, such that the cross-modal context encodings receive contextual data that can then be passed to each of the first modal stream 240 and the second modal stream 250 (e.g., in subsequent updates).

In some embodiments, one or more transformer layers can include cross-attention operation(s) (in alternative and/or in addition to cross-modal context encodings), such that a subset of a layer can be computer with attention over another (optionally overlapping and/or coincident) subset of the layer. In this example expressive framework, a cross-attention operation can be computed between two tensors X and Y, where X forms the query and Y forms the keys and values which are used to reweight the query, as MCA(X,Y)=Attention(W^{Q}X, W^{K}Y, W^{v}Y). In this manner, for instance, a portion of a transformer layer (e.g., corresponding to X) can be updated with cross-attention over another portion of the layer (e.g., corresponding to Y), including the entire layer. In this manner, for instance, separate parameters can be used to update different portions of the layer. For instance, in some embodiments, cross-modal data interchange may be implemented (e.g., in portion 302) by updating one or more of the first modal unit(s) 344 while attending over an entire layer (e.g., including corresponding second modal unit(s), such as a complete layer in portion 301), and by updating one or more of the second modal unit(s) 344 while attending over an entire layer (e.g., including corresponding first modal unit(s), such as a complete layer in portion 301). In some embodiments, updates to each of the first modal stream 240 and the second modal stream 250 can be computed according to separate sets of learnable parameters. In some embodiments, updates to the cross-modal context encodings can be computed in this manner, such as by determining updates to the cross-modal context encodings while attending over the entire preceding layer, optionally according to a separate set of learnable parameters.

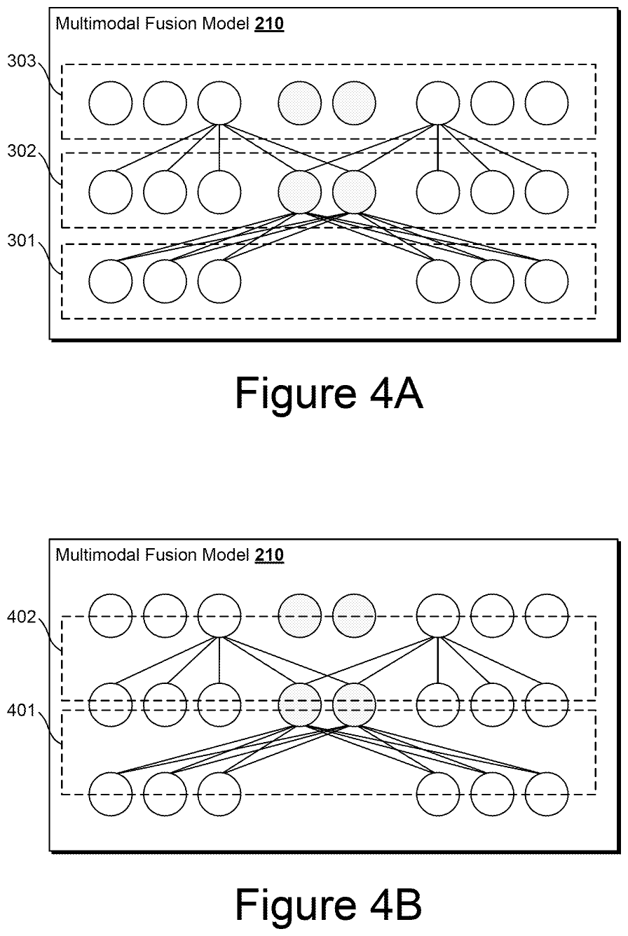

FIGS. 4A and 4B provide further illustration of an example multimodal fusion model. In FIG. 4A, portions 301, 302, and 303 are illustrated as containing layers of nodes, with the left-side blank nodes indicating a first modal stream, the center filled nodes indicating cross-modal context encodings, and the right-side blank nodes indicating a second modal stream. In FIG. 4B, selected model compute operations 401 and 402 are illustrated by connected nodes. At 401, the cross-modal context encodings can receive input from the preceding layer of nodes for each modality (e.g., from portion 301). As illustrated at 402, one or more nodes of each of the modalities can receive input from their respective preceding nodes as well as the cross-modal context encodings. In this manner, for instance, embodiments of the multimodal fusion model 210 can provide cross-modal context to the respective modal streams in a concentrated representation. For instance, nodes of one stream can obtain contextual information without needing to attend over the entirety of the width of the other stream. FIGS. 4A and 4B depict multimodal fusion model 210 as containing three stream nodes and two cross-modal context encodings, but it is to be understood that the number of stream nodes can be any value, such as any value greater than the number of cross-modal context encodings. Similarly, it is to be understood that the number of cross-modal context encodings can be any value, such as any value less than the number of stream nodes (e.g., stream nodes in a corresponding layer).

Although FIGS. 4A and 4B depict connections between particular nodes, it is to be understood that the illustrated connections are drawn for example purposes only. For instance, one or more other modal nodes can be connected to the cross-modal context encodings and/or one or more preceding modal nodes according to example aspects of the present disclosure. Likewise, other arrangements of connections between the cross-modal context encoding(s) and the modal nodes are contemplated. For instance, in some embodiments, the cross-modal context encoding(s) are symmetric—for instance, one or more of the cross-modal context encoding(s) can be connected equivalently to each modal stream (e.g., each cross-modal context encoding connected over both the modal stream, etc.). In some embodiments, the cross-modal context encoding(s) are asymmetric—for instance, one or more of the cross-modal context encoding(s) can be connected to a first modal stream, and one or more other cross-modal context encoding(s) can be connected to a second modal stream (e.g., a plurality of cross-modal context encoding(s) in a layer connected to different modal streams).

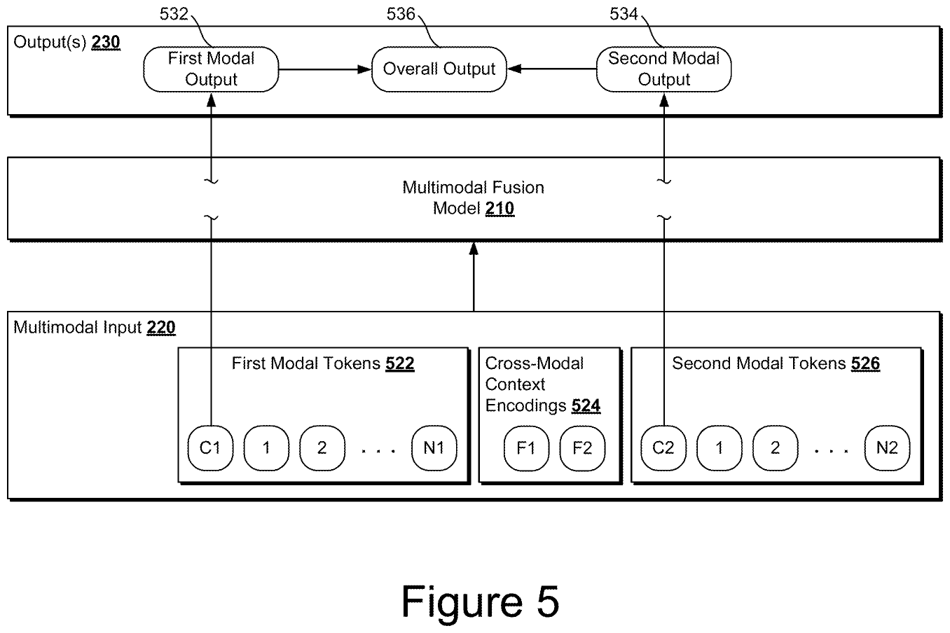

FIG. 5 depicts a block diagram illustrating example aspects of example embodiments of multimodal input 220 and output 230. For instance, in some embodiments, multimodal input 220 includes first modal tokens 522, cross-modal context encodings 524, and second modal tokens 526. For example, in some embodiments, first modal tokens 522 can include a classification token C1 and data tokens 1, 2, . . . , N1; second modal tokens 526 can include a classification token C2 and data tokens 1, 2, . . . , N2; and cross-modal context encodings 524 can include fusion tokens F1, F2, etc. The multimodal input 220 can be provided to the multimodal fusion model 210 for processing according to the present disclosure.

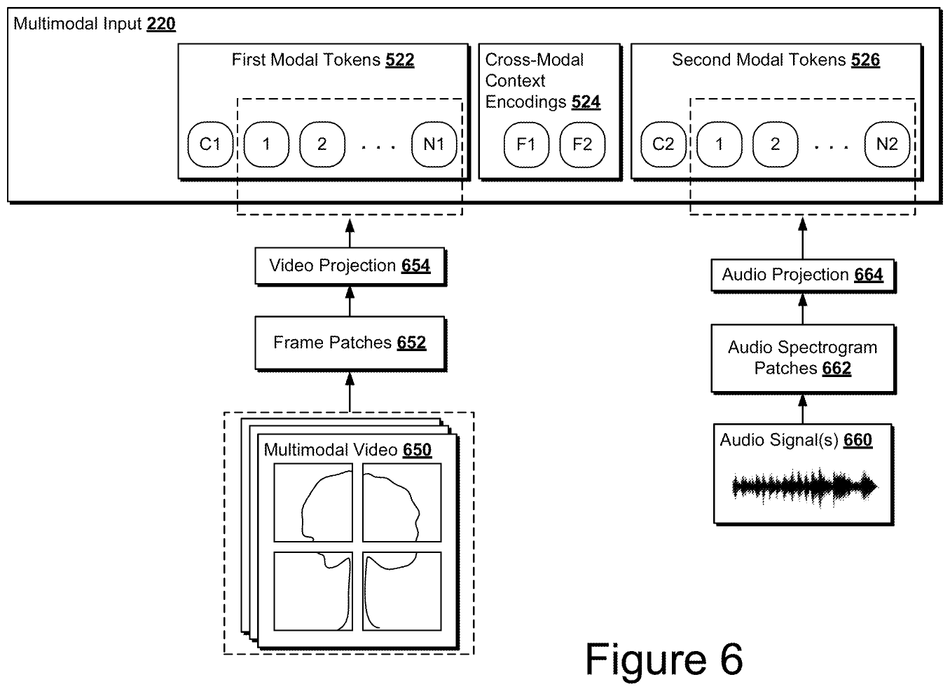

In some embodiments, as illustrated in FIG. 6, the multimodal input 220 can include data tokens obtained from multimodal video 650. In some embodiments, raw video data can be decomposed into tokens. In some embodiments, tokens 1, 2, . . . , N1 can represent video data samples (e.g., one or more frames, or portions of frames at a sample time). In some embodiments, one or more frames of a multimodal video 650 (e.g., video content containing one or more audio channels) can be decomposed into frame patches 652 (e.g., optionally overlapping frame patches containing pixel values extracted from one or more frames of the multimodal video 650) and transformed according to a video projection 654 into a sequence of data tokens 1, 2, . . . , N1. Video projection 654 can, in some embodiments, include a linear projection mapping one or more patches of the frame patches 652 into token space. For example, each patch can be mapped to a token. In some embodiments, video projection 654 can include one or more machine-learned parameters for performing the projection.

In some embodiments, the multimodal input 220 can include data tokens obtained from audio signal(s) 660. In some embodiments, raw audio data can be decomposed into tokens. In some embodiments, tokens 1, 2, . . . , N2 can represent audio waveform samples (e.g., frequency and/or magnitude at a sample time). In some embodiments, tokens 1, 2, . . . , N2 can represent waveform energy spectrum data. In some embodiments, the audio signal(s) 660 can be decomposed into audio spectrogram patches 662 (e.g., optionally overlapping patches of rasterized audio spectrograms, such as log mel spectrograms) and transformed according to an audio projection 664 into a sequence of data tokens 1, 2, . . . , N2. Audio projection 664 can, in some embodiments, include a linear projection mapping one or more patches of the audio spectrogram patches 662 into token space. For example, each patch can be mapped to a token. In some embodiments, audio projection 664 can include one or more machine-learned parameters for performing the projection.

In some embodiments, the first modal tokens 522 and/or the second modal tokens 526 and/or the cross-modal context encodings 524 can also correspond to a positional encoding (e.g., a respective positional encoding any one or more of the first modal tokens 522 and/or the second modal tokens 526 and/or the cross-modal context encodings 524). For example, in some embodiments, a positional encoding can be added to the token value and/or concatenate with the token value. In some embodiments, the positional encoding(s) can be machine-learned.

In some embodiments, tokens 1, 2, . . . , N1 and tokens 1, 2, . . . , N2 can be synchronously sampled (e.g., be obtained from corresponding time(s) in the multimodal input data). In some embodiments, tokens 1, 2, . . . , N1 and tokens 1, 2, . . . , N2 can be asynchronously sampled (e.g., be obtained from different time(s) in the multimodal input data, such as from random times).

With reference again to FIG. 5, an output 230 may be obtained based on the processing of the multimodal input 220. The output 230 can include, in some embodiments, a first modal output 532, a second modal output 534, and an overall output based at least in part on at least one of the first modal output 532 or the second modal output 534. The first modal output 532 and/or the second modal output 534 can include a classification output (e.g., a score, label, probability distribution over classes, etc.) for the respective modal stream based on the respective classification token (e.g., C1, C2). The overall output 536 can include an output determined based on the first modal output 532 and/or the second modal output 534. For example, the first modal output 532 and/or the second modal output 534 can be passed to a classifier (e.g., a linear classifier). In some embodiments, the first modal output 532 and the second modal output 534 can be combined (e.g., averaged, etc.) and a classification can be determined for the overall output 536 based on the combination of the first modal output 532 and the second modal output 534.

### Example Methods

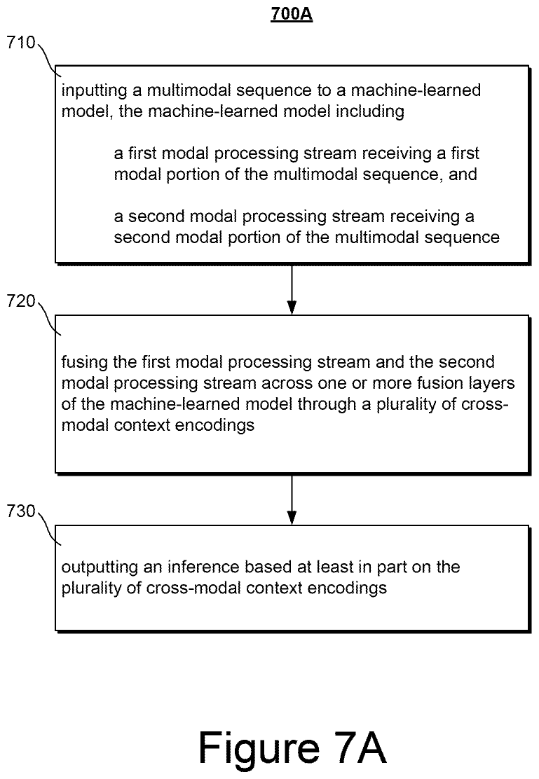

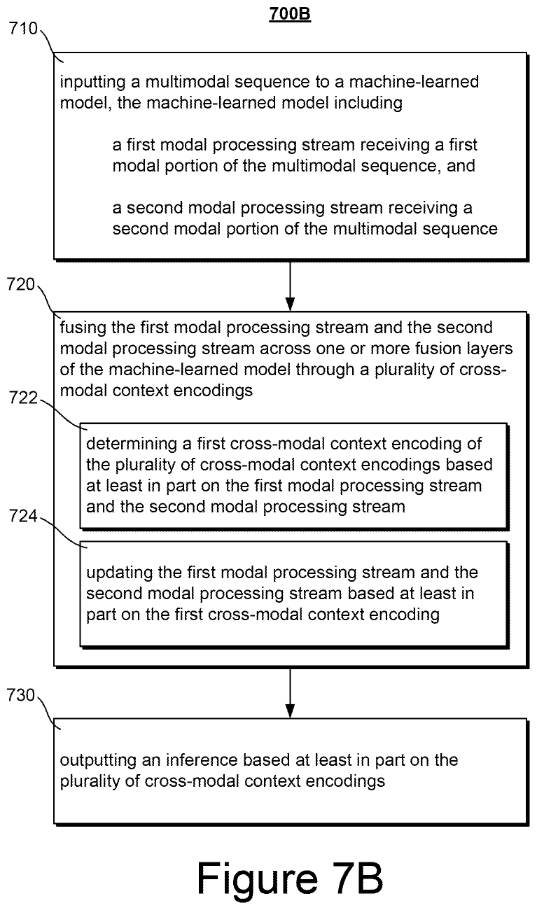

FIG. 7A depicts a flow chart diagram of an example method to perform according to example embodiments of the present disclosure (e.g., by one or more computing systems, such as systems discussed herein with respect to FIGS. 1 to 6). Although FIG. 7A depicts steps performed in a particular order for purposes of illustration and discussion, the methods of the present disclosure are not limited to the particularly illustrated order or arrangement. The various steps of the method 700A can be omitted, rearranged, combined, and/or adapted in various ways without deviating from the scope of the present disclosure.

At 710, example method 700A includes inputting a multimodal sequence to a machine-learned model. In example method 700A, the machine-learned model can include a first modal processing stream receiving a first modal portion of the multimodal sequence and a second modal processing stream receiving a second modal portion of the multimodal sequence. For example, with reference to FIG. 2, in some embodiments, the machine-learned model can include a multimodal fusion model 210 with first modal stream 240 (e.g., receiving first modal data 222) and second modal stream 250 (e.g., receiving second modal data 224). In some embodiments, the first modal processing stream and the second modal processing stream include one or more separate learnable parameters (e.g., optionally sharing one or more parameters while having one or more separate parameters, optionally sharing no parameters, such as being completely independently parameterized, etc.).

At 720, example method 700A includes fusing the first modal processing stream and the second modal processing stream across one or more fusion layers of the machine-learned model through a plurality of cross-modal context encodings. For example, with reference to FIGS. 2 and 3, first modal stream 240 can be fused with second modal stream 250 across one or more fusion layers (e.g., one or more layers of portion 303 using cross-modal inputs) using cross-modal context encodings 260. In some embodiments, the machine-learned model includes one or more unfused layers preceding the one or more fusion layers.

In some embodiments, the machine-learned model includes cross-modal attention connections passing through the plurality of cross-modal context encodings. In some embodiments, the plurality of cross-modal context encodings form attention bottlenecks. In some embodiments, a layer of the machine-learned model includes a plurality of first modal nodes of the first modal processing stream, a plurality of second modal nodes of the second modal processing stream, and a set of cross-modal context encodings of the plurality of cross-modal context encodings. In some embodiments, the set of cross-modal context encodings have lower dimensionality than at least one of (i) the plurality of first modal nodes or (ii) the plurality of second modal nodes.

At 730, example method 700A includes outputting an inference based at least in part on the plurality of cross-modal context encodings. For example, with reference to FIGS. 2 and 5, the output inference can include output(s) 230, such as an overall output 536 based at least in part on a first modal output 532 and a second modal output 534. In some embodiments, outputting the inference includes determining, by the computing system, an overall output based at least in part on a first modal output and a second modal output. In some embodiments, the first modal output and the second modal output are respectively output from the first modal processing stream and the second modal processing stream.

FIG. 7B depicts a flow chart diagram of an example method to perform according to example embodiments of the present disclosure (e.g., by one or more computing systems, such as systems discussed herein with respect to FIGS. 1 to 6). Although FIG. 7B depicts steps performed in a particular order for purposes of illustration and discussion, the methods of the present disclosure are not limited to the particularly illustrated order or arrangement. The various steps of the method 700B can be omitted, rearranged, combined, and/or adapted in various ways without deviating from the scope of the present disclosure.

Example method 700B includes portions 710, 720, and 730 of example method 700A (e.g., and any of or all of various embodiments thereof). At 722, example method 700B additionally includes determining a first cross-modal context encoding of the plurality of cross-modal context encodings based at least in part on the first modal processing stream and the second modal processing stream. For example, with reference to FIG. 4B, in some embodiments, method 700B at 722 can correspond to an update 401 of one or more cross-modal context encodings (shaded nodes) based on one or more first modal nodes (left-side blank nodes) and based on one or more second modal nodes (right-side blank nodes).

At 724, example method 700B additionally includes updating the first modal processing stream and the second modal processing stream based at least in part on the first cross-modal context encoding. For example, with reference to FIG. 4B, in some embodiments, method 700B at 724 can correspond to an update 402 of one or more first modal nodes (left-side blank nodes) based on preceding first modal nodes and one or more cross-modal context encodings (shaded nodes), and/or an update 402 of one or more second modal nodes (right-side blank nodes) based on preceding second modal nodes and one or more cross-modal context encodings.

### Example Results

For illustration purposes only, an example multimodal fusion model will be constructed according to example aspects of the present disclosure and applied to a video classification task.

The present example application is performed over three video classification datasets: AudioSet, Epic-Kitchens-100, and VGGSound. AudioSet contains almost 2 million 10-second video clips from videos hosted on an online video sharing website, annotated with 527 class labels. A balanced training set containing 20,361 clips was selected (henceforth referred to as mini-AudioSet or miniAS), and 18,589 clips were selected for a test set. While the unbalanced training set is large (almost 2 million samples), in the present example application, the model is trained on a (slightly more) balanced subset containing 500K samples (henceforth referred to as AS-500K). Because each sample has multiple labels, we train with a binary cross-entropy (BCE) loss and report mean average precision (mAP) over all classes, following standard practice. Epic-Kitchens 100 contains egocentric videos capturing daily kitchen activities. The dataset consists of 90,000 variable length clips spanning 100 hours. Results for Epic-Kitchens 100 are reported for action recognition following standard protocols—each action label is a combination of a verb and noun, and both are predicted, using a single network with two ‘heads’ trained with a cross-entropy loss. The top scoring verb and action pair predicted by the network are used, and Top-1 action accuracy is the primary metric reported in the present example. Actions in this dataset are mainly short-term (average length is 2.6 s with minimum length 0.25 s). VGGSound contains almost 200K video clips of length 10 s, annotated with 309 sound classes consisting of human actions, sound-emitting objects, and human-object interactions. Unlike AudioSet, the sound source for each clip is ‘visually present’ in the video. This was ensured during dataset creation through the use of image classifiers. After filtering clips that are no longer available on a public web video sharing site, 172,427 training and 14,448 test clips are obtained. We train with a standard cross-entropy loss for classification and report Top-1 and Top-5 classification accuracy.

In the present example, the backbone architecture for each modal processing stream follows that of ViT-Base of Dosovitskiy et al., An Image is Worth 16×16 Words: Transformers for Image Recognition at Scale, arXiv:2010.11929 (2020), with parameters (ViT-B, L=12, NH=12, d=3072) and initialized from ImageNet-21K. It is to be understood, however, that the ViT-Base backbone is selected for illustrative purposes only, and that the systems and methods of the present disclosure are agnostic to backbone selection and can be applied to any other backbone (e.g., any other transformer backbone architecture).

Unless otherwise indicated, four cross-modal context encodings are used.

Training: In the present example, input video content is randomly sampled in clips of t seconds. RGB frames for all datasets are extracted at 25 fps. For AudioSet and VGGSound, eight RGB frames are sampled over the sampling window of length t with a uniform stride of length (t×25)/8. From each frame of size 224×224, 16×16 patches are extracted, giving a total of 8×14×14=1568 patches per video. For Epic-Kitchens (because the segments are shorter), 32 frames are sampled with stride 1. Audio for all datasets in the present example is sampled at 16 kHz and converted to mono channel. In the present example, log mel spectrograms with a frequency dimension of 128 are computed using a 25 ms Hamming window with hop length 10 ms. This gives in the present example an input of size 128×100t fort seconds of audio. Spectrogram patches are extracted with size 16×16, giving 8×50=400 patches for 8 seconds of audio. In the present example, for images, the standard data augmentations of random crop, flip, and color jitter are applied, and for spectrograms, SpecAugment is used with a max time mask length of 192 frames and max frequency mask length of 48 bins following AST. In the present example, Mixup is used with α=0.3 and stochastic depth regularization with probability p=0.3. In the present example, all models (across datasets) are trained with a batch size of 64, synchronous stochastic gradient descent with momentum of 0.9, and a cosine learning rate schedule with warmup of 2.5 epochs on tensor processing unit (TPU) accelerators. In the present example, the base learning rate is set to 0.5, and training is conducted for 50 epochs.

Inference: Following standard practice, multiple temporal crops are uniformly sampled from the clip and average per-view logits to obtain the final result. The number of test crops is set to 4.

Table 1 contains the results of mean average precision (mAP) tests for different models over different training datasets compared to the present example. As can be seen in Table 1, the present example can offer improved mAP when trained on the same dataset (MiniAS). Further, even when trained on a much smaller data set (FullAS-500k compared to FullAS-2M), the present example can offer improved mAP.

TABLE 1
Comparison with prior models.

| Model | Training Dataset | mAP |
|---|---|---|
| GBlend | MiniAS | 37.8 |
| GBlend | FullAS-2M | 41.8 |
| Attn Audio-Visual | FullAS-2M | 46.2 |
| Perceiver | FullAS-2M | 44.2 |
| The Present Example | MiniAS | 43.9 |
| The Present Example | FullAS-500k | 52.1 |

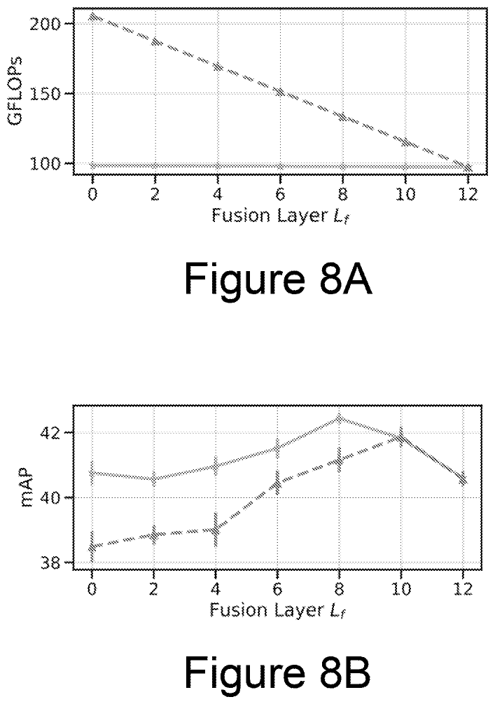

FIG. 8A contains results from a comparison of the present example (solid line), channeling cross-modal contextual data through the cross-modal context encodings beginning with a fusion layer L_{f}, with a modified example (dashed line) in which full pairwise attention is performed across the parallel modal streams beginning with fusion layer L_{f}. As can be seen in FIG. 8A, the modified example has higher compute requirements, especially when fusion is provided earlier in the modal streams. FIG. 8B contains results from another comparison of the present example (solid line) with the modified example (dashed line). The present example provides higher mAP with lower compute requirements.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A system for multimodal data processing with improved cross-modal attention, comprising:
one or more processors; and
one or more non-transitory computer-readable media that collectively store instructions that, when executed by the one or more processors, cause the system to perform operations, the operations comprising:
inputting a multimodal sequence to a machine-learned model, the machine-learned model comprising:
a first modal processing stream receiving a first modal portion of the multimodal sequence, and
a second modal processing stream receiving a second modal portion of the multimodal sequence;
fusing the first modal processing stream and the second modal processing stream across one or more fusion layers of the machine-learned model through a plurality of cross-modal context encodings; and
outputting an inference based at least in part on the plurality of cross-modal context encodings.

2. The system of claim 1, wherein the machine-learned model comprises one or more unfused layers preceding the one or more fusion layers.

3. The system of claim 1, wherein fusing the first modal processing stream and the second modal processing stream comprises:
determining a first cross-modal context encoding of the plurality of cross-modal context encodings based at least in part on the first modal processing stream and the second modal processing stream; and
updating the first modal processing stream and the second modal processing stream based at least in part on the first cross-modal context encoding.

4. The system of claim 1, wherein the machine-learned model comprises cross-modal attention connections passing through the plurality of cross-modal context encodings.

5. The system of claim 4, wherein the plurality of cross-modal context encodings form attention bottlenecks.

6. The system of claim 5, wherein a layer of the machine-learned model comprises:
a plurality of first modal nodes of the first modal processing stream;
a plurality of second modal nodes of the second modal processing stream; and
a set of cross-modal context encodings of the plurality of cross-modal context encodings, the set of cross-modal context encodings having lower dimensionality than at least one of (i) the plurality of first modal nodes or (ii) the plurality of second modal nodes.

7. The system of claim 1, wherein the first modal processing stream and the second modal processing stream comprise one or more separate learnable parameters.

8. The system of claim 1, wherein the operations further comprise:
receiving one or more images and one or more audio recordings associated with the one or more images;
flattening the one or more images into an image data sequence to form the first modal portion; and
obtaining an audio data sequence from the one or more audio recordings to form the second modal portion.

9. The system of claim 1, wherein outputting the inference based at least in part on the plurality of cross-modal context encodings comprises:
determining an overall output based at least in part on a first modal output and a second modal output, wherein the first modal output and the second modal output are respectively output from the first modal processing stream and the second modal processing stream.

10. A computer-implemented method for multimodal data processing with improved cross-modal attention, comprising:
inputting, by a computing system comprising one or more processors, a multimodal sequence to a machine-learned model, the machine-learned model comprising:
a first modal processing stream receiving a first modal portion of the multimodal sequence, and
a second modal processing stream receiving a second modal portion of the multimodal sequence;
fusing, by the computing system, the first modal processing stream and the second modal processing stream across one or more fusion layers of the machine-learned model through a plurality of cross-modal context encodings; and
outputting, by the computing system, an inference based at least in part on the plurality of cross-modal context encodings.

11. The method of claim 10, wherein the machine-learned model comprises one or more unfused layers preceding the one or more fusion layers.

12. The method of claim 10, wherein fusing the first modal processing stream and the second modal processing stream comprises:
determining, by the computing system, a first cross-modal context encoding of the plurality of cross-modal context encodings based at least in part on the first modal processing stream and the second modal processing stream; and
updating, by the computing system, the first modal processing stream and the second modal processing stream based at least in part on the first cross-modal context encoding.

13. The method of claim 10, wherein the machine-learned model comprises cross-modal attention connections passing through the plurality of cross-modal context encodings.

14. The method of claim 10, wherein the first modal processing stream and the second modal processing stream comprise one or more separate learnable parameters.

15. The method of claim 13, wherein the plurality of cross-modal context encodings form attention bottlenecks.

16. The method of claim 15, wherein a layer of the machine-learned model comprises:
a plurality of first modal nodes of the first modal processing stream;
a plurality of second modal nodes of the second modal processing stream; and
a set of cross-modal context encodings of the plurality of cross-modal context encodings, the set of cross-modal context encodings having lower dimensionality than at least one of (i) the plurality of first modal nodes or (ii) the plurality of second modal nodes.

17. The method of claim 10, further comprising:
receiving, by the computing system, one or more images and one or more audio recordings associated with the one or more images;
projecting, by the computing system, the one or more images into an image data sequence to form the first modal portion; and
obtaining, by the computing system, an audio data sequence from the one or more audio recordings to form the second modal portion.

18. The method of claim 10, wherein outputting the inference based at least in part on the plurality of cross-modal context encodings comprises:
determining, by the computing system, an overall output based at least in part on a first modal output and a second modal output, wherein the first modal output and the second modal output are respectively output from the first modal processing stream and the second modal processing stream.

19. A system for audiovisual data processing with improved cross-modal attention, comprising:
one or more processors; and
one or more non-transitory computer-readable media that collectively store instructions that, when executed by the one or more processors, cause the system to perform operations, the operations comprising:
inputting a multimodal sequence to a machine-learned model, the machine-learned model comprising:
a visual processing stream receiving a visual portion of the multimodal sequence, and
an audio processing stream receiving an audio portion of the multimodal sequence;
fusing the visual processing stream and the audio processing stream across one or more fusion layers of the machine-learned model through a plurality of cross-modal context encodings, the cross-modal context encodings representing concentrated attention flow between the visual processing stream and the audio processing stream, and the one or more fusion layers following one or more unfused layers; and
outputting an inference based at least in part on the plurality of cross-modal context encodings.

20. The system of claim 19, wherein the operations further comprise:
updating, based at least in part on the inference,
one or more parameters of the visual processing stream,
one or more parameters of the audio processing stream, and
one or more of the plurality of cross-modal context encodings.
